(19) United States
(12) Patent Application Publication
(10) Pub. No.: US 2026/0082241 A1
(43) Pub. Date: Mar. 19, 2026

(54) MACHINE LEARNING FOR CHANNEL ESTIMATE

(71) Applicant: Lenovo (United States) Inc., Morrisville, NC (US)

(72) Inventors: Mahdi Barzegar Khalilsarai, Berlin (DE); Venkata Srinivas Kothapalli, Ottawa (CA)

(73) Assignee: Lenovo (United States) Inc., Morrisville, NC (US)

(21) Appl. No.: 18/885,051

(22) Filed: Sep. 13, 2024

(51) Int. Cl. H04W 24/02; G06N 20/00; H04L 25/02

(52) U.S. Cl. CPC H04W 24/02; G06N 20/00; H04L 25/0224

(57) ABSTRACT

Various aspects of the present disclosure relate to machine learning for channel estimate. An apparatus, such as a user equipment (UE) and/or network equipment, receives one or more reference signals (RS) that correspond to one or more RS resources for a channel. The apparatus generates a channel estimate for the channel via a machine learning model, wherein one or more model parameters for the machine learning model are configured based at least in part on the one or more RS.

### TECHNICAL FIELD

The present disclosure relates to wireless communications, and more specifically to machine learning for channel estimation in wireless communications.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system may support wireless communications, and may include one or more devices, such as UEs, base stations (e.g., gNBs), network entities, satellites, and/or network equipment (NE), among other devices, that transmit and/or receive signaling.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may include a UE for wireless communication to receive one or more reference signals (RS) that correspond to one or more RS resources for a channel; and generate a channel estimate for the channel via a machine learning model, wherein one or more model parameters for the machine learning model are configured based at least in part on the one or more RS.

In some implementations of the method and apparatuses described herein, the machine learning model is configured to map input of a first dimension to output of a second dimension, and wherein the at least one processor is configured to cause the UE to: generate an input vector based at least in part on the first dimension; and generate the channel estimate according to the second dimension and based at least in part on the one or more model parameters and the input vector; the at least one processor is configured to cause the UE to generate the input vector as a random vector including one or more of a multi-variate random Gaussian vector or a random vector with independently and uniformly distributed elements; the at least one processor is configured to cause the UE to generate the input vector based on a pre-training of the machine learning model, where the pre-training of the machine learning model is performed based at least in part on a dataset including channel samples and respective RS; the at least one processor is configured to cause the UE to receive a configuration message for the machine learning model including one or more of an architecture of the machine learning model, the first dimension, the second dimension, a number of neurons, or a type of activation function; the machine learning model includes one or more of a parameterized generative model or a deep neural network; the at least one processor is configured to cause the UE to receive one or more of mean values or covariance values of the one or more model parameters of the machine learning model; the at least one processor is configured to cause the UE to further determine the one or more model parameters based at least in part on the one or more of the mean values or the covariance values, in addition to the one or more RS; the UE includes one of a UE or a network equipment.

Some implementations of the method and apparatuses described herein may include a UE for wireless communication to transmit one or more RS that correspond to one or more RS resources for a channel; and transmit a configuration message for a machine learning model configured to generate a channel estimate for the channel using model parameters determined based at least in part on the one or more RS.

In some implementations of the method and apparatuses described herein, the configuration message for the machine learning model includes one or more of an architecture of the machine learning model, a first dimension for input of the machine learning model, a second dimension for output of the machine learning model, a number of neurons, or a type of activation function; the machine learning model includes one or more of a parameterized generative model or a deep neural network; the at least one processor is configured to cause the UE to transmit one or more of mean values or covariance values of one or more model parameters of the machine learning model; the UE includes one of a UE or a network equipment.

Some implementations of the method and apparatuses described herein may further include a processor for wireless communication to receive one or more RS that correspond to one or more RS resources for a channel; and generate a channel estimate for the channel via a machine learning model, wherein one or more model parameters for the machine learning model are configured based at least in part on the one or more RS.

Some implementations of the method and apparatuses described herein may further include a processor for wireless communication to transmit one or more RS that correspond to one or more RS resources for a channel; and transmit a configuration message for a machine learning model configured to generate a channel estimate for the channel using model parameters determined based at least in part on the one or more RS.

Some implementations of the method and apparatuses described herein may further include a method performed by a UE, the method including receiving one or more RS that correspond to one or more RS resources for a channel; and generating a channel estimate for the channel via a machine learning model, wherein one or more model parameters for the machine learning model are configured based at least in part on the one or more RS.

In some implementations of the method and apparatuses described herein, the method further comprising where the machine learning model is configured to map input of a first dimension to output of a second dimension, and wherein the method further includes: generating an input vector based at least in part on the first dimension; and generating the channel estimate according to the second dimension and based at least in part on the one or more model parameters and the input vector; generating the input vector as a random vector including one or more of a multi-variate random Gaussian vector or a random vector with independently and uniformly distributed elements; generating the input vector based on a pre-training of the machine learning model, where the pre-training of the machine learning model is performed based at least in part on a dataset including channel samples and respective RS; receiving a configuration message for the machine learning model including one or more of an architecture of the machine learning model, the first dimension, the second dimension, a number of neurons, or a type of activation function; the machine learning model includes one or more of a parameterized generative model or a deep neural network; receiving one or more of mean values or covariance values of the one or more model parameters of the machine learning model; determining the one or more model parameters based at least in part on the one or more of the mean values or the covariance values, in addition to the one or more RS.

Some implementations of the method and apparatuses described herein may further include a method performed by a UE, the method including transmitting one or more RS that correspond to one or more RS resources for a channel; and transmitting a configuration message for a machine learning model configured to generate a channel estimate for the channel using model parameters determined based at least in part on the one or more RS.

In some implementations of the method and apparatuses described herein, the method further comprising where the configuration message for the machine learning model includes one or more of an architecture of the machine learning model, a first dimension for input of the machine learning model, a second dimension for output of the machine learning model, a number of neurons, or a type of activation function; the machine learning model includes one or more of a parameterized generative model or a deep neural network; transmitting one or more of mean values or covariance values of one or more model parameters of the machine learning model.

Some implementations of the method and apparatuses described herein may further include a NE for wireless communication to receive one or more RS that correspond to one or more RS resources for a channel; and generate a channel estimate for the channel via a machine learning model, wherein one or more model parameters for the machine learning model are configured based at least in part on the one or more RS.

In some implementations of the method and apparatuses described herein, the machine learning model is configured to map input of a first dimension to output of a second dimension, and wherein the at least one processor is configured to cause the NE to: generate an input vector based at least in part on the first dimension; and generate the channel estimate according to the second dimension and based at least in part on the one or more model parameters and the input vector; the at least one processor is configured to cause the NE to generate the input vector as a random vector including one or more of a multi-variate random Gaussian vector or a random vector with independently and uniformly distributed elements; the at least one processor is configured to cause the NE to generate the input vector based on a pre-training of the machine learning model, where the pre-training of the machine learning model is performed based at least in part on a dataset including channel samples and respective RS; the at least one processor is configured to cause the NE to receive a configuration message for the machine learning model including one or more of an architecture of the machine learning model, the first dimension, the second dimension, a number of neurons, or a type of activation function; the machine learning model includes one or more of a parameterized generative model or a deep neural network; the at least one processor is configured to cause the NE to receive one or more of mean values or covariance values of the one or more model parameters of the machine learning model; the at least one processor is configured to cause the NE to further determine the one or more model parameters based at least in part on the one or more of the mean values or the covariance values, in addition to the one or more RS.

Some implementations of the method and apparatuses described herein may further include a NE for wireless communication to transmit one or more RS that correspond to one or more RS resources for a channel; and transmit a configuration message for a machine learning model configured to generate a channel estimate for the channel using model parameters determined based at least in part on the one or more RS.

In some implementations of the method and apparatuses described herein, the configuration message for the machine learning model includes one or more of an architecture of the machine learning model, a first dimension for input of the machine learning model, a second dimension for output of the machine learning model, a number of neurons, or a type of activation function; the machine learning model includes one or more of a parameterized generative model or a deep neural network; the at least one processor is configured to cause the NE to transmit one or more of mean values or covariance values of one or more model parameters of the machine learning model.

Some implementations of the method and apparatuses described herein may further include a method performed by a NE, the method including receiving one or more RS that correspond to one or more RS resources for a channel; and generating a channel estimate for the channel via a machine learning model, wherein one or more model parameters for the machine learning model are configured based at least in part on the one or more RS.

In some implementations of the method and apparatuses described herein, the method further comprising where the machine learning model is configured to map input of a first dimension to output of a second dimension, and wherein the method further includes: generating an input vector based at least in part on the first dimension; and generating the channel estimate according to the second dimension and based at least in part on the one or more model parameters and the input vector; generating the input vector as a random vector including one or more of a multi-variate random Gaussian vector or a random vector with independently and uniformly distributed elements; generating the input vector based on a pre-training of the machine learning model, where the pre-training of the machine learning model is performed based at least in part on a dataset including channel samples and respective RS; receiving a configuration message for the machine learning model including one or more of an architecture of the machine learning model, the first dimension, the second dimension, a number of neurons, or a type of activation function; the machine learning model includes one or more of a parameterized generative model or a deep neural network; receiving one or more of mean values or covariance values of the one or more model parameters of the machine learning model; determining the one or more model parameters based at least in part on the one or more of the mean values or the covariance values, in addition to the one or more RS.

Some implementations of the method and apparatuses described herein may further include a method performed by a NE, the method including transmitting one or more RS that correspond to one or more RS resources for a channel; and transmitting a configuration message for a machine learning model configured to generate a channel estimate for the channel using model parameters determined based at least in part on the one or more RS.

In some implementations of the method and apparatuses described herein, the method further comprising where the configuration message for the machine learning model includes one or more of an architecture of the machine learning model, a first dimension for input of the machine learning model, a second dimension for output of the machine learning model, a number of neurons, or a type of activation function; the machine learning model includes one or more of a parameterized generative model or a deep neural network; transmitting one or more of mean values or covariance values of one or more model parameters of the machine learning model.

### BRIEF DESCRIPTION OF THE DRAWINGS

FIG. 1 illustrates an example of a wireless communications system in accordance with aspects of the present disclosure.

FIG. 2 illustrates channel estimation in accordance with one or more scenarios.

FIG. 3 illustrates an example autoencoder in accordance with aspects of the present disclosure.

FIG. 4 illustrates an example variational autoencoder in accordance with aspects of the present disclosure.

FIG. 5 illustrates an example generative adversarial network in accordance with aspects of the present disclosure.

FIG. 6 illustrates example normalizing flows in accordance with aspects of the present disclosure.

FIG. 7 illustrates an example of a UE in accordance with aspects of the present disclosure.

FIG. 8 illustrates an example of a processor in accordance with aspects of the present disclosure.

FIG. 9 illustrates an example of a NE in accordance with aspects of the present disclosure.

FIG. 10 illustrates a flowchart of a method in accordance with aspects of the present disclosure.

FIG. 11 illustrates a flowchart of a method in accordance with aspects of the present disclosure.

### DETAILED DESCRIPTION

In a wireless communications system, a UE and a NE (e.g., a base station, gNB) may support wireless communication (e.g., reception and/or transmission of wireless communication) using time-frequency resources. To optimize wireless communication using time-frequency resources, channel state information (CSI) can be utilized to determine properties of wireless signal communicated between UEs and NEs. CSI, for instance, consists of information about a communication channel between a UE and NE over time (OFDM symbols), frequency (OFDM subcarriers), and space (transmit and receive antennas). This information can be used for coherent reception/transmission of data between the UE and NE by effective combining/precoding of transmitted data.

In scenarios, CSI acquisition can be achieved by an estimation of channel coefficients using RS which are known to both the transmitter and the receiver. Channel estimation in multiple input multiple output (MIMO) OFDM systems can be performed using linear methods, such as a least squares (LS) method or a linear minimum mean squared error (L-MMSE) method. However, to yield accurate channel estimates, these methods may require many RS transmissions or knowledge of channel statistics which is often unavailable due to the quick change in statistics and the short communication time between two nodes. This issue can be further pronounced when the channel dimensions grow, as in the case of massive MIMO where the number of service antennas is large, requiring more RS to enable an estimation of the new channel dimensions.

Deep neural networks (DNNs) have been applied to channel estimation in MIMO OFDM systems. DNNs can identify an optimized, non-linear mapping between the RS and channel estimate with a more favorable RS overhead-estimation accuracy trade-off. Using DNNs for CSI, for instance, can first use a standard channel estimator such as the LS estimator followed by DNN-based denoising and interpolation/super-resolution.

The present disclosure presents channel estimation techniques based at least in part on generative models. A DNN may require training with a dataset of many samples that is generated according to data statistics, e.g., channel statistics. The collection of this dataset requires expending significant RS resources, which in turn compromises the benefit of using a DNN model. Accordingly, the present disclosure presents a flexible solution based on an untrained deep generative model that does not need training with previous samples of the channel. Further the described solutions are flexible to incorporate a given dataset of samples to improve estimation quality if such a dataset is given. Thus the described solutions can provide flexibility in performing channel estimation with a machine learning model even when only a small dataset of samples is available.

The described solutions can utilize pre-trained networks and untrained networks to estimate a channel in space, time, and frequency, given a number of RS received signals that is potentially much smaller than the total dimension of the channel. One advantage of using an untrained generative model is that a network node (e.g., NE) does not need to spend resources to collect a dataset to train the model. On the other hand, if the network node has access to a small dataset, the proposed solutions are able to utilize the dataset to improve channel estimates by providing the untrained network with a latent variable input that is obtained from the network node and trained by the small dataset.

By performing the described techniques, a device in a wireless communications system can improve channel estimates (e.g., CSI) and thus improve signal quality of wireless signal transmitted in wireless communications systems.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

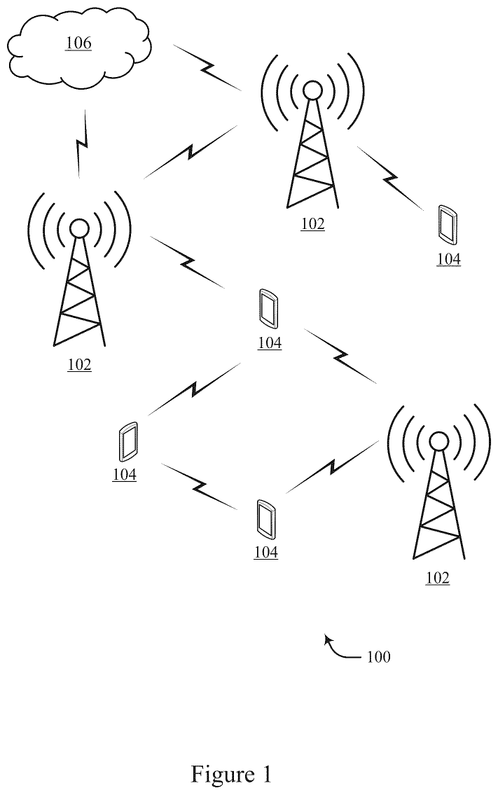

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, a network element, a network function, a network entity, a radio access network (RAN), a NodeB, an eNodeB (CNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a NE 102 and/or a UE 104 receives one or more RS that correspond to one or more RS resources for a channel. The NE 102 and/or UE 104 generates a channel estimate for the channel via a machine learning model, wherein one or more model parameters for the machine learning model are configured based at least in part on the one or more RS. As discussed herein, model parameters of a machine learning model can represent information that can be used to configure operation of a machine learning model. Parameters of a machine learning model, for instance, can represent configuration variables that are internal to the model the values of which can be estimated from given data, e.g., RS data that is received by a node such as a UE and/or NE.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

With reference to channel estimation (e.g., CSI), consider a transmitter and a receiver with M and N antenna ports, respectively. The transmitter can, for example, can be a UE and the receiver a gNB or vice versa. The channel frequency response corresponding to subcarrier f and OFDM symbol t can be expressed by a complex-valued matrix H_{f,t} of dimension N×M that represents channel fading coefficients for each pair of transmit and receive antennas in a resource element (RE) specified by (f,t). To enable channel estimation, the transmitter sends a set of RS over a set of RS resources to the receiver. These reference signals are known to the receiver and the received signal on the RS resources can therefore be used to estimate the channel. Mathematically, the received signal is expressed as

$${y}_{i} = {H}_{{f}_{i} , {t}_{i}} {φ}_{i} + {z}_{i} i = 1 , … , τ \qquad ( 1 )$$

where i is the index of a RS resource transmitted on subcarrier fᵢ and symbol tᵢ, τ is the total number of transmitted RS, φᵢ is a complex-valued vector of dimension M whose element symbols are transmitted from the M transmit antenna ports, and z; is additive (Gaussian) noise. The receiver aims to estimate H_{f,t} for all subcarriers and symbols in a given range, i.e. t=t₀+mtₛ, m=0, . . . , T−1, and f=f₀+nfₛ, n=0, . . . , F−1, where tₛ denotes symbol duration and fₛ denotes subcarrier spacing.

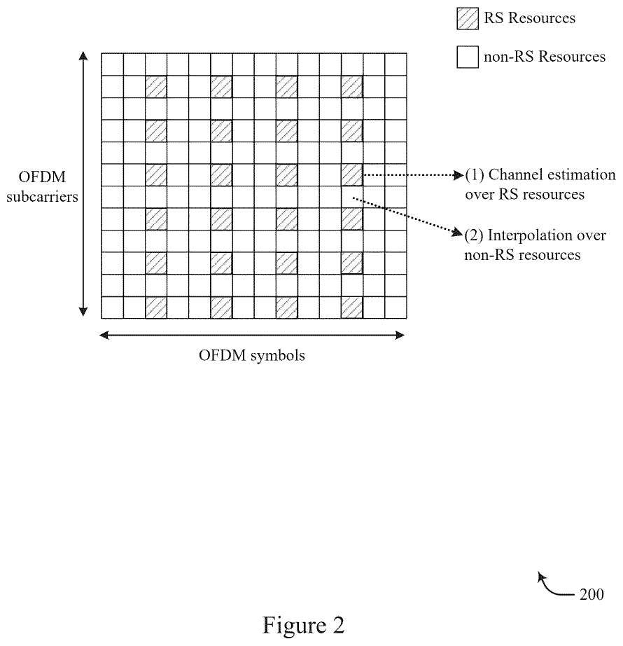

FIG. 2 illustrates channel estimation 200 in accordance with one or more scenarios. For instance, based at least in part on the channel estimation 200, two steps can be involved: estimating the channel on RS resources and interpolation to estimate channel over non-RS resources. For estimating the channel on RS resources, the channel can be estimated over the REs dedicated to RS given the noisy received signal above. Two common methods of estimation are LS and minimum mean squared error (MMSE) estimation. The LS estimate is given by

$${\hat{H}}_{{f}_{i} , {t}_{i}}^{L S} = arg {min}_{X} {‖ {y}_{i} - X {φ}_{i} ‖}^{2} \qquad ( 2 )$$

simply finding the channel coefficients that minimize squared Euclidean error. The MMSE estimate is given by

$${\hat{H}}_{{f}_{i} , {t}_{i}}^{M M S E} = E [ {H}_{{f}_{i} , {t}_{i}} \vert {y}_{i} ] . \qquad ( 3 )$$

namely the expected value of the channel given the RS. Unlike LS, MMSE estimation requires knowledge of the channel and noise statistics to compute the conditional expectation above. In this sense MMSE estimation is not always possible due to the lack of such statistical knowledge, although it yields much more accurate channel estimates compared to LS.

For interpolation to estimate channel over non-RS resources, channel estimates Ĥ_{f}_{ᵢ}_{,t}_{ᵢ},i=1, . . . , τ, are interpolated to estimate the channel over all other resources for which no RS is transmitted. The simplest option is to use linear interpolation and nearest neighbor interpolation, and more advanced methods include piece-wise linear interpolation, and spline interpolation, and MMSE interpolation which exploits channel correlation in time and frequency.

Additionally, channel estimation based on compressed sensing has been proposed. The idea behind this approach is to exploit the inherent sparsity of a multi-path channel to estimate the channel from relatively few RS. To see this, note that the channel can be expressed as

$${H}_{{f}_{i} , {t}_{i}} = {\sum }_{ℓ = 1}^{L} {x}_{ℓ} {e}^{j 2 π {v}_{ℓ} {f}_{i}} {e}^{- j 2 π {f}_{i} {τ}_{ℓ}} {a}_{R} ( {θ}_{R}^{( ℓ )} ) {{a}_{T} ( {θ}_{T}^{( ℓ )} )}^{H} \qquad ( 4 )$$

where L denotes the number of paths in a multi-path environment, [symbol] denotes the path index, and
[symbol] is the complex gain of the [symbol] -th path.

$${θ}_{R}^{( ℓ )}$$

is the angle of arrival (AoA) at the receiver array of the [symbol] -th path.

$${θ}_{T}^{( ℓ )}$$

is the angle of departure (AoD) at the transmitter array of the [symbol] -th path.

$${a}_{R} ( {θ}_{R}^{( ℓ )} )$$

is the so-called array response of the receiver array of dimension N.

$${a}_{T} ( {θ}_{T}^{( ℓ )} )$$

is the array response of the transmit array of dimension M.
[symbol] is the delay associated with the [symbol] -th path.
[symbol] is the Doppler frequency associated with the [symbol] -th path.
(·)^{H} denotes Hermitian.

Each path can be associated with an AoA-AoD-delay-Doppler tuple

$$( {θ}_{r}^{( ℓ )} , {θ}_{t}^{( ℓ )} , {τ}_{ℓ} , {ν}_{ℓ} )$$

and the number of paths can be much smaller than the total channel dimension (L<<MNFT). This enables the use of sparse recovery techniques that can estimate the channel coefficients and their location in the AoA-AoD-delay-Doppler domain given a number of RS that is much less than the total channel dimension. To do this the channel is first represented as

$$H = {\sum }_{ℓ = 0}^{L} {x}_{ℓ} {a}_{R} ( {θ}_{R}^{( ℓ )} ) \cdot {{a}_{T} ( {θ}_{T}^{( ℓ )} )}^{*} \cdot b ( {τ}_{ℓ} ) \cdot c ( {v}_{ℓ} ) \qquad ( 5 )$$

where ∘ denotes outer product and H is a 4D tensor, b( [symbol] )=[1, [symbol] , . . . , [symbol] ]^{T} and c( [symbol] )=[1, [symbol] , . . . , [symbol] ]^{T}. This tensor is then vectorized and approximated as

$$v e c ( H ) \approx A x \qquad ( 6 )$$

where A is an overcomplete dictionary of dimension MNFT×G, where G>MNFT and the i-th column of A is given by

$${[ A ]}_{. , i} = {a}_{R} ( {\tilde{θ}}_{R}^{( i )} ) ⊗ {{a}_{T} ( {\tilde{θ}}_{T}^{( i )} )}^{*} ⊗ b ( {\tilde{τ}}_{i} ) ⊗ c ( {\tilde{ν}}_{i} )$$

where the parameters

$$( {\tilde{θ}}_{R}^{( i )} , {\tilde{θ}}_{T}^{( i )} , {\tilde{τ}}_{i} , {\tilde{ν}}_{i} )$$

belong to a dense grid on the AoA-AoD-delay-Doppler space. In addition x in (5) is a sparse vector, i.e. it has few non-zero elements. One example of a sparse recovery method is to solve the following optimization problem:

$$mini m {ize}_{x} {‖ y - Φ Ax ‖}^{2} + λ {‖ x ‖}_{1} \qquad ( 7 )$$

Φ is a matrix of dimension τ×MNFT where row i contains the RS signal φᵢ in the appropriate location, ∥x∥₁ is the [symbol] ₁ norm and λ>0 is a regularization scalar. The [symbol] ₁ norm promotes sparsity in the solution and is proved to be effective in sparse recovery. Once the sparse coefficients are computed, the channel is reconstructed by vec(H*)=Ax*. Note that this method performs both steps (estimation and interpolation) at once.

Deep generative models are a class of machine learning algorithms that are capable of generating new data samples that are similar to the training data, but not necessarily identical. This is unlike traditional learning models, which are limited to predicting the target variable based on the input features. Deep generative models attempt to learn the probability distribution underlying a dataset that is presented to them. This is achieved by using a DNN consisting of multiple layers of interconnected neurons. Each layer learns to transform the input data into a higher-level representation, allowing the model to capture complex patterns and relationships in the data.

The generator of a generative model can be denoted by a parameterized function G(·; θ): [symbol] ^{k}→ [symbol] ^{d} mapping samples from a tractable distribution in the space [symbol] ^{k} to samples from (typically) complex distributions in [symbol] ^{d}. One application of generative models can be to first generate samples from a tractable, simple distribution and then obtain samples of the intractable distribution by feeding the former to a generator. The sample inputs to the generator are called latent variables and the input space of the generator can be referred to as the latent space. The output space of the generator can be referred to as the target space.

The dimension of the latent variables k can be much smaller than d. This is because the variables in the target space are generally “compressible”, e.g., their content can be captured in a dimension that is much smaller the dimension d that they are represented in. In particular, the channel might consist of thousands of coefficients over space, time and frequency, but it can be represented by a set of few parameters that correspond to angle, delay and Doppler taps and their corresponding coefficients. In other words, the channel lives on a complicated manifold. The goal of a generative model can be to learn the mapping from the lower-dimensional latent space to the target space of channels. The following discussion presents some examples of deep generative models.

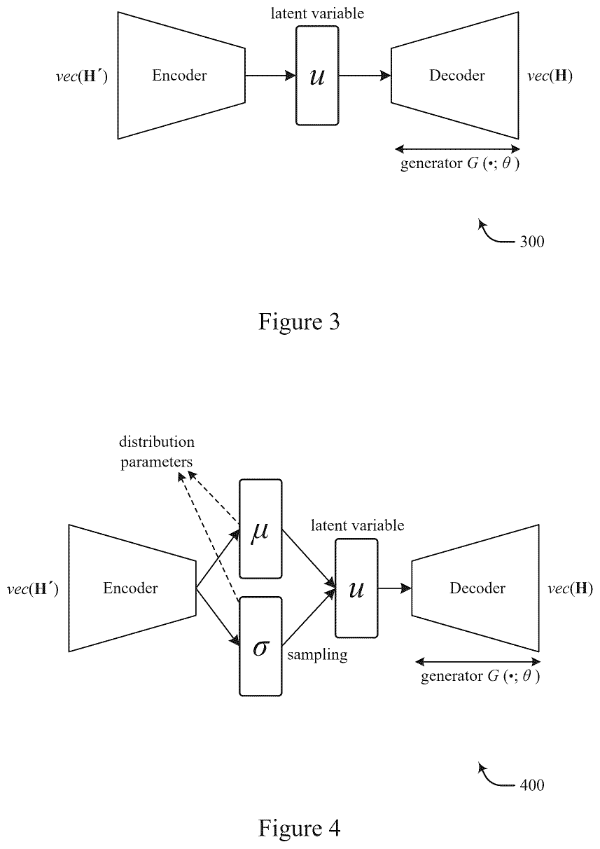

FIG. 3 illustrates an example autoencoder 300 in accordance with aspects of the present disclosure. The autoencoder 300 includes an encoder and a decoder. The encoder maps from a data space to a latent space u of lower dimension and the decoder maps from the latent space to the data space. The autoencoder 300, for instance, can be used for data compression. The decoder in the autoencoder 300 can represent a generator. Further, the variable H′ denotes a counterpart of the channel H with a same dimension.

FIG. 4 illustrates an example variational autoencoder 400 in accordance with aspects of the present disclosure. According to implementations, the variational autoencoder 400 represents a neural network that learns to map input data into a lower-dimensional representation (latent space) by an encoder, and then reconstructs the original data from this representation by a decoder. The variational autoencoder can learn the parameters of a probability distribution (e.g. Gaussian) over a latent space and new data can be generated by sampling from this distribution and running the sampled data through the decoder.

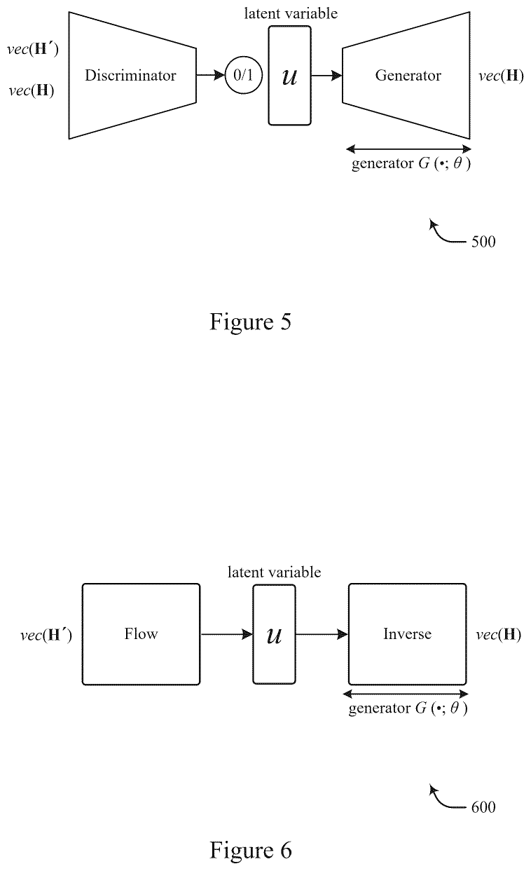

FIG. 5 illustrates an example generative adversarial network 500 in accordance with aspects of the present disclosure. According to implementations, the generative adversarial network 500 consists of two neural networks: a generator network that generates new data samples, and a discriminator network that tries to distinguish between real and generated data. The two networks can be trained together. The generator produces synthetic data samples, while the discriminator evaluates them against real data and the goal is for the generator to produce samples that cannot be distinguished from real data and in this way the network can generate data that, despite being synthetic, can be highly realistic.

FIG. 6 illustrates example normalizing flows 600 in accordance with aspects of the present disclosure. The normalizing flows 600 represent a type of generative model that transforms a simple distribution (e.g. Gaussian) into a more complex distribution that matches the data distribution. Operation of the normalizing flows 600 can be done through a series of invertible and differentiable mappings, using which the model can map between the data and latent space in both directions.

In implementations let G(·; θ): [symbol] ^{k}→ [symbol] ^{d} denote the generator of a generative model that maps samples from a latent Euclidean space of dimension k to a data space of dimension d=2NMFT (the factor 2 appears because we transform the complex channel coefficients to real values), which we shall call the range of the generator. The architecture of the model, including the number and type of its layers (fully connected, convolutional, etc.), the number of neurons per layer and the type of activation functions can be determined either by the node itself, or specified by a different node and communicated with the current node. We assume that the generative model is untrained, i.e. the parameters θ are not previously optimized based on a dataset and they will be optimized based on a single observation as explained below.

In implementations channel estimation can be performed at any node, for example the gNB or the UE. An example procedure for channel estimation is presented hereafter. In implementations, Node 1 (e.g. UE) receives RS from Node 2 (e.g. gNB). The RS can be, for example, sounding reference signals (SRS), demodulation reference signal (DM-RS), CSI-RS, tracking reference signal (TRS), or any other type of RS from one node to another. The number of RS resources can be denoted by τ, each transmitted on an RE.

The signal received at RE (fᵢ,tᵢ) at Node 1 can be given by

$${y}_{i} = {H}_{{f}_{i} , {t}_{i}} {φ}_{i} + {z}_{i} , i = 1 , … , τ$$

where H_{f}_{ᵢ}_{,t}_{ᵢ} is the channel between the two nodes of dimension N×M, N is the number of antenna ports at Node 1 and M is the number of antenna ports at Node 2. We can stack the N-dimensional received signals yᵢ for i=1, . . . , τ to construct a super-vector of dimension Nτ denoted by y. This vector can be expressed as

$$y = Φ vec ( H ) + z$$

where H is the channel tensor of dimension N×M×F×T, vec(H) is its vectorization of dimension NMFT×1 (or d×1), Φ is a matrix of dimension Nτ×NMFT and z is the noise vector of dimension Nt. Each row of Φ contains NFT blocks of elements, each of dimension M, where all blocks except one are equal to zero and the non-zero block contains the transmit RS from the M UE antennas φᵢ corresponding to the i-th RS resource.

Further to the example procedure, Node 1 can determine a solution to the following optimization problem:

$$minim {ize}_{θ} {‖ y - Φ G ( u ; θ ) ‖}^{2} + R ( θ )$$

where R(·): [symbol] ^{k}→ [symbol] ₊ is a regularization term which we will discuss below, and where u is a randomly generated and then fixed vector, for example a vector randomly generated according to a multi-dimensional Gaussian or uniform distribution, e.g.,

$$u \sim multi - variate uniform or Gaussian distribution .$$

In implementations the output of the optimizer can be denoted by θ*. Solving this optimization problem is equivalent to finding the model parameters that such that the generated channel G(u; θ) induces a small measurement error, regularized with a function of the parameters. The regularization term R(θ) can take on various forms to promote solutions that match better to the a priori knowledge about the model parameters. The following discussion presents examples of a regularization term.

In a first example, the regularization term promotes sparsity in the output of the model. From equation (6) above, a channel can be sparse in the spatial-delay-Doppler domain, or equivalently, the channel can be approximated as vec(H)≈Ax where x is a sparse vector. Sparsity can be promoted in the output by defining the regularization term as

$$R ( θ ) = {λ}_{1} {‖ {A}^{H} G ( u ; θ ) ‖}_{1} .$$

where λ₁ is a regularization scalar. This will promote those model parameters that result in outputs that are sparse in the representation matrix A.

In implementations, Node 1 that is to estimate the channel can have a small dataset of samples from other similar channels and received RS signals, using which Node 1 can determine model parameters that better match the statistics of the channel. In such scenarios, the small dataset can be used to determine the parameters of a prior distribution of the generative model parameters. It has been observed that the weights in a trained generative convolutional network can follow a Gaussian distribution. In addition, in finding a solution to the optimization problem, Node 1 can use a gradient based method which is initialized with a first solution. This first solution itself can be produced according to a Gaussian distribution as well. Combining these two observations, a prior on the weights of the network can be imposed as a vector Gaussian distribution. This statistical view of the weights can be represented by the prior distribution given as

$$p ( θ ) = \frac{1}{{( 2 π )}^{\frac{{N}_{θ}}{2}} {\vert {Σ}_{θ} \vert}^{\frac{1}{2}}} exp ( - \frac{1}{2} {( θ - {μ}_{θ} )}^{H} {Σ}_{θ}^{- 1} ( θ - {μ}_{θ} ) ) ,$$

where N_{w} is the number of parameters (length of θ), μ_{θ} is the mean parameter of the distribution of dimension N_{θ} and Σ_{θ} is the covariance parameter of dimension N_{w}×N_{w}.

Additionally, with the log-likelihood of the observations, given Gaussian additive noise of the RS received signal model, is given by

$$log p ( y \vert θ ) = - α {‖ y - Φ G ( u ; θ ) ‖}^{2} + β$$

where α and β are constats. Given the above probability functions we can derive the posterior distribution of the model parameters given the RS as

$$- log p ( θ \vert y ) = α {‖ y - Φ G ( u ; θ ) ‖}^{2} + \frac{1}{2} {( θ - {μ}_{θ} )}^{H} {Σ}_{θ}^{- 1} ( θ - {μ}_{θ} ) + c o n s t .$$

With this optimization of the model parameters may be formulated as a maximum a posteriori (MAP) estimation problem where the posterior likelihood of the parameters is maximized. This is equivalent to:

$${minimize}_{θ} {‖ y - Φ G ( u ; θ ) ‖}^{2} + {{λ}_{2} ( θ - {μ}_{θ} )}^{H} {Σ}_{θ}^{- 1} ( θ - {μ}_{θ} )$$

where λ₂>0 is a regularization scalar which controls the weight of the prior distribution. The regularization term can be given by

$$R ( θ ) = {{λ}_{2} ( θ - {μ}_{θ} )}^{H} {Σ}_{θ}^{- 1} ( θ - {μ}_{θ} ) .$$

In implementations the prior distribution parameters μ_{θ} and Σ_{θ} can be obtained based on the small dataset that is available in Node 1. Let {y⁽¹⁾, . . . , y⁽ⁿ⁾} denote received RS signals over n RS transmissions. These RS measurements can be obtained using various RS (e.g. DM-RS, CSI-RS, SRS, TRS, etc.), which can indicate that the measurement matrix Φ might be different for each RS transmission. However the dimension of RS can be the same in each instance. Given {y⁽¹⁾, . . . , y⁽ⁿ⁾}, Node 1 trains the generator with the cost function given as minimize_{θ} ∥y−ΦG(u; θ)∥²+λ₁∥A^{H}G(u;θ)∥₁ and obtains the model parameters {θ⁽¹⁾, . . . , θ⁽ⁿ⁾}. Then based on the obtained parameters, the mean and variances μ_{θ} and Σ_{θ} will be computed. This can be done in various ways. In one example, they can be estimated as

$${μ}_{θ} = \frac{1}{n} {\sum }_{i = 1}^{n} {θ}^{( i )} and {Σ}_{θ} = \frac{1}{n - 1} {\sum }_{i = 1}^{n} ( {θ}^{( i )} - {μ}_{θ} ) {( {θ}^{( i )} - {μ}_{θ} )}^{H} .$$

The distribution parameters may be difficult to compute at the current node, for example because the current may not have access to a dataset. Therefore in at least one implementation the possibility is provided of the weight distribution parameters to be transferred from another node to the current node. For example, a gNB may have access to the mean and covariance of weight parameters of a specific generative model based on its previous observations of channels and RS received signals. These parameters can then be transferred to a UE, which then estimates the channel by optimizing the parameters of the same generative model, given the mean and covariance parameters.

In implementations, if Node 1 additionally has access to n ground-truth channels or an estimate of them {Ĥ⁽¹⁾, . . . , Ĥ⁽ⁿ⁾} it can further improve the performance of the proposed techniques. Such implementations can occur, for example, when Node 1 has previously estimated the channel from received RS using conventional methods such as LS and MMSE and thereby has accumulated a small dataset of estimated channels. Node 1 can then use this dataset to increase channel estimation accuracy such as discussed in the following. First, Node 1 can train the generative model with the n channel estimates and their corresponding RS {y⁽¹⁾, . . . , y⁽ⁿ⁾} to obtain a first set of optimized model parameters θ⁽⁰⁾. Second, Node 1 finds a vector in the latent space u₀ such that:

$${u}^{( 0 )} = arg {min}_{u} {‖ y - Φ G ( u ; {θ}^{( 0 )} ) ‖}^{2}$$

Where y is the current received RS. Note that here, instead of optimizing over model parameters, optimization can occur over the latent space. If the number of available samples n is large, an estimate of the channel obtained as Ĥ=G(u⁽⁰⁾;θ⁽⁰⁾) can be better than the estimate obtained by an untrained network. However, if the number of samples is small, then the trained model can yield poor channel estimates. In such scenarios, the solution u⁽⁰⁾ obtained by the pre-trained model (with few samples) can be used and fed as the initial input in the original optimization problem based on the untrained network. For instance, u⁽⁰⁾ can be used instead of a randomly generated latent space input. This can take the form:

$${minimize}_{θ} {‖ y - Φ G ( {u}^{( 0 )} ; θ ) ‖}^{2} + R ( θ ) .$$

The initialization in this way has the advantage that the optimizer starts from a point that is likely closer to a good solution compared to a completely random initial value.

In a further example implementation, the regularization terms in the previous two examples can be combined to provide

$$R ( θ ) = {λ}_{1} ‖ {A}^{H} G ( u ; θ ) {‖}_{1} + {{λ}_{2} ( θ - {μ}_{θ} )}^{H} {Σ}_{θ}^{- 1} ( θ - {μ}_{θ} ) .$$

In implementations, the optimization problem above can be solved using gradient-based techniques. If the generator G(·;θ) is differentiable with respect to θ, the gradient of the cost function with respect to θ can be computed using backpropagation which is a fast and efficient method of computing derivatives. The solver terminates after a number of steps at a solution which we call θ*. Then, the estimate of the channel in this way is given by

$$\hat{H} = G ( {u}^{⋆} ; {θ}^{⋆} ) ,$$

where u* is randomly generated and/or generated after solving the optimization problem with the pre-trained model.

Implementations also provide for choosing the dimension of the latent space in a machine learning model. The dimension of a latent space (e.g., input space of a model generator) can have an impact on the performance of the generative model and consequently channel estimation. For instance, the dimension of the latent space can affect (e.g., determine) the amount of information that can be compressed by the model and recovered from the model. Implementations described herein can include various ways of selecting a dimension for the latent space, and selection can be done in a pilot phase when the model is initially trained, e.g., not in a phase of channel estimation).

Ways for choosing the dimension of the latent space in a machine learning model can include cross validation and model order selection via principal component analysis (PCA). In cross validation, a training dataset and a separate validation dataset can be fixed. The generative model can be trained for different values of latent space dimension and for each latent space dimension an inference error (loss) of the model can be computed on the validation set. The latent space dimension that yields the least error can then be selected. In an example this process can be done offline in the pilot phase as the model is being trained.

For model order selection via PCA, PCA can be applied to the dataset that is used to train the model, which reveals the inherent dimension of data by sorting the principal components according to their variance. The latent space dimension is then given by the number of components that have the highest variance, which can be determined by setting a threshold and counting the number of components whose variance is higher than the threshold. Note that the dimension of the latent space can be specified by the node itself and/or specified by another node and communicated to the current node.

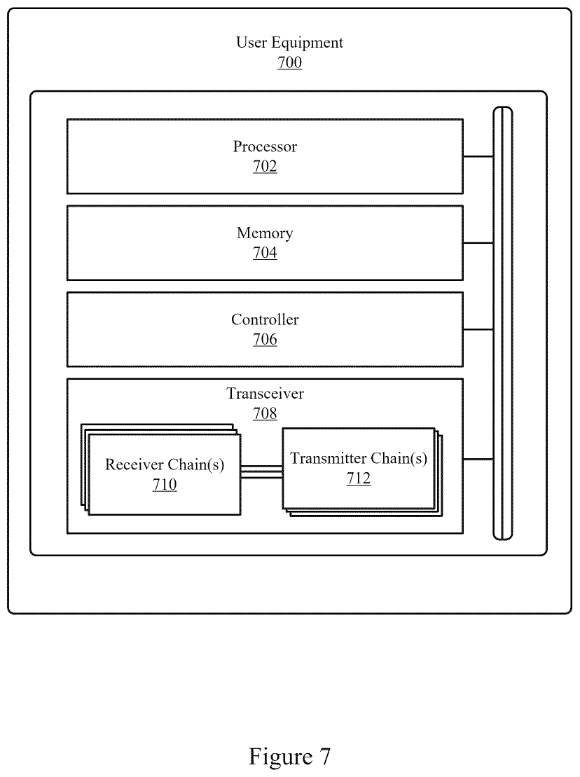

FIG. 7 illustrates an example of a UE 700 in accordance with aspects of the present disclosure. The UE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the UE 700 to perform various functions of the present disclosure.

The memory 704 may include volatile or non-volatile memory. The memory 704 may store computer-readable, computer-executable code including instructions when executed by the processor 702 cause the UE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the UE 700 to perform one or more of the functions described herein (e.g., executing, by the processor 702, instructions stored in the memory 704).

For example, the processor 702 may support wireless communication at the UE 700 in accordance with examples as disclosed herein. The UE 700 may be configured to or operable to support a means for receiving one or more RS that correspond to one or more RS resources for a channel; and generating a channel estimate for the channel via a machine learning model, wherein one or more model parameters for the machine learning model are configured based at least in part on the one or more RS.

Additionally, the UE 700 may be configured to support any one or combination of the machine learning model is configured to map input of a first dimension to output of a second dimension, and wherein the method further includes: generating an input vector based at least in part on the first dimension; and generating the channel estimate according to the second dimension and based at least in part on the one or more model parameters and the input vector; generating the input vector as a random vector including one or more of a multi-variate random Gaussian vector or a random vector with independently and uniformly distributed elements; generating the input vector based on a pre-training of the machine learning model, where the pre-training of the machine learning model is performed based at least in part on a dataset including channel samples and respective RS; receiving a configuration message for the machine learning model including one or more of an architecture of the machine learning model, the first dimension, the second dimension, a number of neurons, or a type of activation function; the machine learning model includes one or more of a parameterized generative model or a deep neural network; receiving one or more of mean values or covariance values of the one or more model parameters of the machine learning model; determining the one or more model parameters based at least in part on the one or more of the mean values or the covariance values, in addition to the one or more RS.

For example, the processor 702 may support wireless communication at the UE 700 in accordance with examples as disclosed herein. The UE 700 may be configured to or operable to support a means for transmitting one or more RS that correspond to one or more RS resources for a channel; and transmitting a configuration message for a machine learning model configured to generate a channel estimate for the channel using model parameters determined based at least in part on the one or more RS.

Additionally, the UE 700 may be configured to support any one or combination of where the configuration message for the machine learning model includes one or more of an architecture of the machine learning model, a first dimension for input of the machine learning model, a second dimension for output of the machine learning model, a number of neurons, or a type of activation function; the machine learning model includes one or more of a parameterized generative model or a deep neural network; transmitting one or more of mean values or covariance values of one or more model parameters of the machine learning model.

Additionally, or alternatively, the UE 700 may support at least one memory (e.g., the memory 704) and at least one processor (e.g., the processor 702) coupled with the at least one memory and configured to cause the UE to receive one or more RS that correspond to one or more RS resources for a channel; and generate a channel estimate for the channel via a machine learning model, wherein one or more model parameters for the machine learning model are configured based at least in part on the one or more RS.

Additionally, the UE 700 may be configured to support any one or combination of where the machine learning model is configured to map input of a first dimension to output of a second dimension, and wherein the at least one processor is configured to cause the UE to: generate an input vector based at least in part on the first dimension; and generate the channel estimate according to the second dimension and based at least in part on the one or more model parameters and the input vector; the at least one processor is configured to cause the UE to generate the input vector as a random vector including one or more of a multi-variate random Gaussian vector or a random vector with independently and uniformly distributed elements; the at least one processor is configured to cause the UE to generate the input vector based on a pre-training of the machine learning model, where the pre-training of the machine learning model is performed based at least in part on a dataset including channel samples and respective RS; the at least one processor is configured to cause the UE to receive a configuration message for the machine learning model including one or more of an architecture of the machine learning model, the first dimension, the second dimension, a number of neurons, or a type of activation function; the machine learning model includes one or more of a parameterized generative model or a deep neural network; the at least one processor is configured to cause the UE to receive one or more of mean values or covariance values of the one or more model parameters of the machine learning model; the at least one processor is configured to cause the UE to further determine the one or more model parameters based at least in part on the one or more of the mean values or the covariance values, in addition to the one or more RS.

Additionally, or alternatively, the UE 700 may support at least one memory (e.g., the memory 704) and at least one processor (e.g., the processor 702) coupled with the at least one memory and configured to cause the UE to transmit one or more RS that correspond to one or more RS resources for a channel; and transmit a configuration message for a machine learning model configured to generate a channel estimate for the channel using model parameters determined based at least in part on the one or more RS.

Additionally, the UE 700 may be configured to support any one or combination of where the configuration message for the machine learning model includes one or more of an architecture of the machine learning model, a first dimension for input of the machine learning model, a second dimension for output of the machine learning model, a number of neurons, or a type of activation function; the machine learning model includes one or more of a parameterized generative model or a deep neural network; the at least one processor is configured to cause the UE to transmit one or more of mean values or covariance values of one or more model parameters of the machine learning model.

The controller 706 may manage input and output signals for the UE 700. The controller 706 may also manage peripherals not integrated into the UE 700. In some implementations, the controller 706 may utilize an operating system such as iOS®, ANDROID®, WINDOWS®, or other operating systems. In some implementations, the controller 706 may be implemented as part of the processor 702.

In some implementations, the UE 700 may include at least one transceiver 708. In some other implementations, the UE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

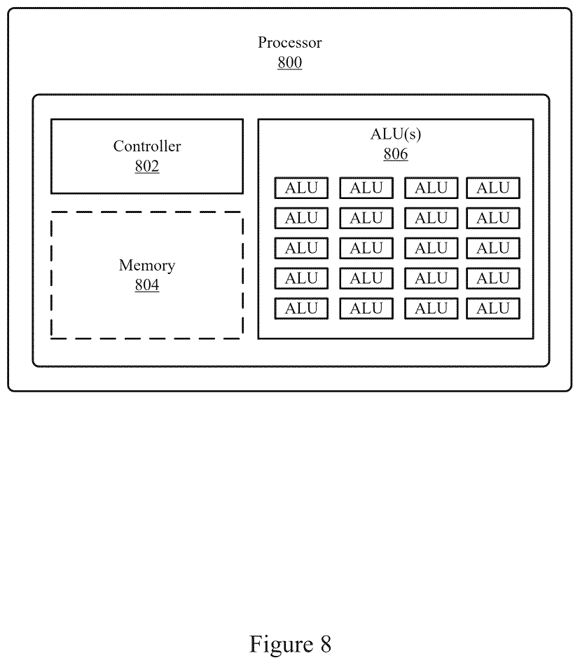

FIG. 8 illustrates an example of a processor 800 in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, which may be, for example, an L1/L2/L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory addresses of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, ALUs 806, and other functional units of the processor 800.

The memory 804 may include one or more caches (e.g., memory local to or included in the processor 800 or other memory, such as RAM, ROM, DRAM, SDRAM, SRAM, MRAM, flash memory, etc. In some implementations, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, and the controller 802, and may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementations, the one or more ALUs 806 may reside within or on a processor chipset (e.g., the processor 800). In some other implementations, the one or more ALUs 806 may reside external to the processor chipset (e.g., the processor 800). One or more ALUs 806 may perform one or more computations such as addition, subtraction, multiplication, and division on data. For example, one or more ALUs 806 may receive input operands and an operation code, which determines an operation to be executed. One or more ALUs 806 may be configured with a variety of logical and arithmetic circuits, including adders, subtractors, shifters, and logic gates, to process and manipulate the data according to the operation. Additionally, or alternatively, the one or more ALUs 806 may support logical operations such as AND, OR, exclusive-OR (XOR), not-OR (NOR), and not-AND (NAND), enabling the one or more ALUs 806 to handle conditional operations, comparisons, and bitwise operations.

The processor 800 may support wireless communication in accordance with examples as disclosed herein. The processor 800 may be configured to or operable to support at least one controller (e.g., the controller 802) coupled with at least one memory (e.g., the memory 804) and configured to cause the processor to receive one or more RS that correspond to one or more RS resources for a channel; and generate a channel estimate for the channel via a machine learning model, wherein one or more model parameters for the machine learning model are configured based at least in part on the one or more RS.

Additionally, the processor 800 may be configured to or operable to support any one or combination of where the machine learning model is configured to map input of a first dimension to output of a second dimension, and wherein the at least one controller is configured to cause the processor to: generate an input vector based at least in part on the first dimension; and generate the channel estimate according to the second dimension and based at least in part on the one or more model parameters and the input vector; the at least one controller is configured to cause the processor to generate the input vector as a random vector including one or more of a multi-variate random Gaussian vector or a random vector with independently and uniformly distributed elements; the at least one controller is configured to cause the processor to generate the input vector based on a pre-training of the machine learning model, where the pre-training of the machine learning model is performed based at least in part on a dataset including channel samples and respective RS; the at least one controller is configured to cause the processor to receive a configuration message for the machine learning model including one or more of an architecture of the machine learning model, the first dimension, the second dimension, a number of neurons, or a type of activation function; the machine learning model includes one or more of a parameterized generative model or a deep neural network; the at least one controller is configured to cause the processor to receive one or more of mean values or covariance values of the one or more model parameters of the machine learning model; the at least one controller is configured to cause the processor to further determine the one or more model parameters based at least in part on the one or more of the mean values or the covariance values, in addition to the one or more RS.

The processor 800 may support wireless communication in accordance with examples as disclosed herein. The processor 800 may be configured to or operable to support at least one controller (e.g., the controller 802) coupled with at least one memory (e.g., the memory 804) and configured to cause the processor to transmit one or more RS that correspond to one or more RS resources for a channel; and transmit a configuration message for a machine learning model configured to generate a channel estimate for the channel using model parameters determined based at least in part on the one or more RS.

Additionally, the processor 800 may be configured to or operable to support any one or combination of where the configuration message for the machine learning model includes one or more of an architecture of the machine learning model, a first dimension for input of the machine learning model, a second dimension for output of the machine learning model, a number of neurons, or a type of activation function; the machine learning model includes one or more of a parameterized generative model or a deep neural network; the at least one controller is configured to cause the processor to transmit one or more of mean values or covariance values of one or more model parameters of the machine learning model.

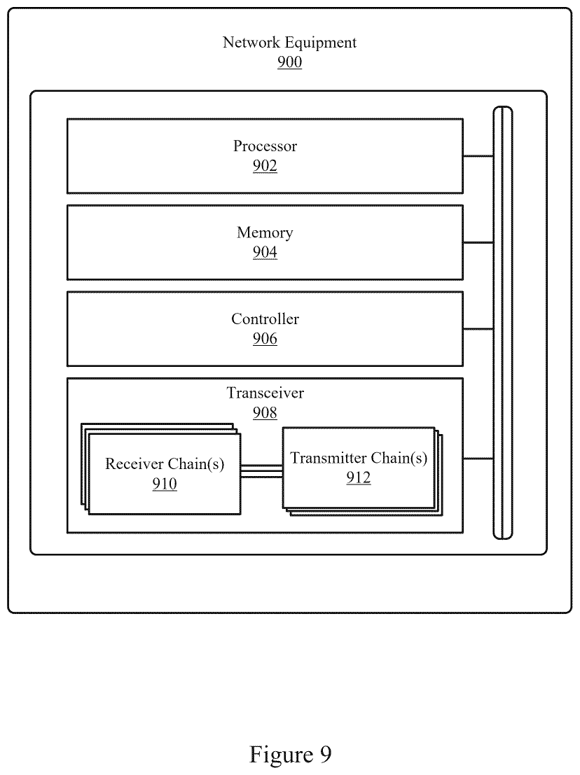

FIG. 9 illustrates an example of a NE 900 in accordance with aspects of the present disclosure. The NE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the NE 900 to perform various functions of the present disclosure.

The memory 904 may include volatile or non-volatile memory. The memory 904 may store computer-readable, computer-executable code including instructions when executed by the processor 902 cause the NE 900 to perform various functions described herein. The code may be stored in a non-transitory computer-readable medium such as the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the NE 900 to perform one or more of the functions described herein (e.g., executing, by the processor 902, instructions stored in the memory 904).

For example, the processor 902 may support wireless communication at the NE 900 in accordance with examples as disclosed herein. The NE 900 may be configured to or operable to support a means for receiving one or more RS that correspond to one or more RS resources for a channel; and generating a channel estimate for the channel via a machine learning model, wherein one or more model parameters for the machine learning model are configured based at least in part on the one or more RS.

Additionally, the NE 900 may be configured to or operable to support any one or combination of where the machine learning model is configured to map input of a first dimension to output of a second dimension, and wherein the method further includes: generating an input vector based at least in part on the first dimension; and generating the channel estimate according to the second dimension and based at least in part on the one or more model parameters and the input vector; generating the input vector as a random vector including one or more of a multi-variate random Gaussian vector or a random vector with independently and uniformly distributed elements; generating the input vector based on a pre-training of the machine learning model, where the pre-training of the machine learning model is performed based at least in part on a dataset including channel samples and respective RS; receiving a configuration message for the machine learning model including one or more of an architecture of the machine learning model, the first dimension, the second dimension, a number of neurons, or a type of activation function; the machine learning model includes one or more of a parameterized generative model or a deep neural network; receiving one or more of mean values or covariance values of the one or more model parameters of the machine learning model; determining the one or more model parameters based at least in part on the one or more of the mean values or the covariance values, in addition to the one or more RS.

For example, the processor 902 may support wireless communication at the NE 900 in accordance with examples as disclosed herein. The NE 900 may be configured to or operable to support a means for transmitting one or more RS that correspond to one or more RS resources for a channel; and transmitting a configuration message for a machine learning model configured to generate a channel estimate for the channel using model parameters determined based at least in part on the one or more RS.

Additionally, the NE 900 may be configured to or operable to support any one or combination of where the configuration message for the machine learning model includes one or more of an architecture of the machine learning model, a first dimension for input of the machine learning model, a second dimension for output of the machine learning model, a number of neurons, or a type of activation function; the machine learning model includes one or more of a parameterized generative model or a deep neural network; transmitting one or more of mean values or covariance values of one or more model parameters of the machine learning model.

Additionally, or alternatively, the NE 900 may support at least one memory (e.g., the memory 904) and at least one processor (e.g., the processor 902) coupled with the at least one memory and configured to cause the NE to receive one or more RS that correspond to one or more RS resources for a channel; and generate a channel estimate for the channel via a machine learning model, wherein one or more model parameters for the machine learning model are configured based at least in part on the one or more RS.

Additionally, the NE 900 may be configured to support any one or combination of where the machine learning model is configured to map input of a first dimension to output of a second dimension, and wherein the at least one processor is configured to cause the NE to: generate an input vector based at least in part on the first dimension; and generate the channel estimate according to the second dimension and based at least in part on the one or more model parameters and the input vector; the at least one processor is configured to cause the NE to generate the input vector as a random vector including one or more of a multi-variate random Gaussian vector or a random vector with independently and uniformly distributed elements; the at least one processor is configured to cause the NE to generate the input vector based on a pre-training of the machine learning model, where the pre-training of the machine learning model is performed based at least in part on a dataset including channel samples and respective RS; the at least one processor is configured to cause the NE to receive a configuration message for the machine learning model including one or more of an architecture of the machine learning model, the first dimension, the second dimension, a number of neurons, or a type of activation function; the machine learning model includes one or more of a parameterized generative model or a deep neural network; the at least one processor is configured to cause the NE to receive one or more of mean values or covariance values of the one or more model parameters of the machine learning model; the at least one processor is configured to cause the NE to further determine the one or more model parameters based at least in part on the one or more of the mean values or the covariance values, in addition to the one or more RS.

Additionally, or alternatively, the NE 900 may support at least one memory (e.g., the memory 904) and at least one processor (e.g., the processor 902) coupled with the at least one memory and configured to cause the NE to transmit one or more RS that correspond to one or more RS resources for a channel; and transmit a configuration message for a machine learning model configured to generate a channel estimate for the channel using model parameters determined based at least in part on the one or more RS.

Additionally, the NE 900 may be configured to support any one or combination of where the configuration message for the machine learning model includes one or more of an architecture of the machine learning model, a first dimension for input of the machine learning model, a second dimension for output of the machine learning model, a number of neurons, or a type of activation function; the machine learning model includes one or more of a parameterized generative model or a deep neural network; the at least one processor is configured to cause the NE to transmit one or more of mean values or covariance values of one or more model parameters of the machine learning model.

The controller 906 may manage input and output signals for the NE 900. The controller 906 may also manage peripherals not integrated into the NE 900. In some implementations, the controller 906 may utilize an operating system such as iOS®, ANDROID®, WINDOWS®, or other operating systems. In some implementations, the controller 906 may be implemented as part of the processor 902.

In some implementations, the NE 900 may include at least one transceiver 908. In some other implementations, the NE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas to receive a signal over the air or wireless medium. The receiver chain 910 may include at least one amplifier (e.g., a low-noise amplifier (LNA)) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

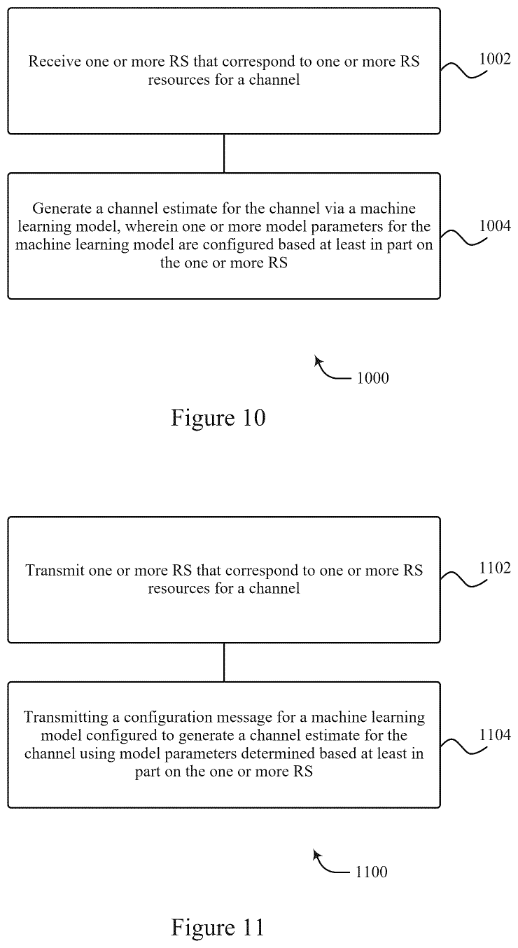

FIG. 10 illustrates a flowchart of a method 1000 in accordance with aspects of the present disclosure. The operations of the method may be implemented by a NE and/or UE as described herein. In some implementations, the NE and/or UE may execute a set of instructions to control the function elements of the NE and/or UE to perform the described functions. It should be noted that the method described herein describes a possible implementation, and that the operations and the steps may be rearranged or otherwise modified and that other implementations are possible.

At 1002, the method may include receiving one or more RS that correspond to one or more RS resources for a channel. The operations of 1002 may be performed in accordance with examples as described herein. In some implementations, aspects of the operations of 1002 may be performed by a UE as described with reference to FIG. 7 and/or a NE as described with reference to FIG. 9.

At 1004, the method may include generating a channel estimate for the channel via a machine learning model, wherein one or more model parameters for the machine learning model are configured based at least in part on the one or more RS. The operations of 1004 may be performed in accordance with examples as described herein. In some implementations, aspects of the operations of 1002 may be performed by a UE as described with reference to FIG. 7 and/or a NE as described with reference to FIG. 9.

FIG. 11 illustrates a flowchart of a method 1100 in accordance with aspects of the present disclosure. The operations of the method may be implemented by a NE and/or UE as described herein. In some implementations, the NE and/or UE may execute a set of instructions to control the function elements of the NE and/or UE to perform the described functions. It should be noted that the method described herein describes a possible implementation, and that the operations and the steps may be rearranged or otherwise modified and that other implementations are possible.

At 1102, the method may include transmitting one or more RS that correspond to one or more RS resources for a channel. The operations of 1102 may be performed in accordance with examples as described herein. In some implementations, aspects of the operations of 1102 may be performed by a UE as described with reference to FIG. 7 and/or a NE as described with reference to FIG. 9.

At 1104, the method may include transmitting a configuration message for a machine learning model configured to generate a channel estimate for the channel using model parameters determined based at least in part on the one or more RS. The operations of 1104 may be performed in accordance with examples as described herein. In some implementations, aspects of the operations of 1102 may be performed by a UE as described with reference to FIG. 7 and/or a NE as described with reference to FIG. 9.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first apparatus for wireless communication, comprising:
at least one memory; and
at least one processor coupled with the at least one memory and configured to cause the first apparatus to:
receive one or more reference signals (RS) that correspond to one or more RS resources for a channel; and
generate a channel estimate for the channel via a machine learning model, wherein one or more model parameters for the machine learning model are configured based at least in part on the one or more RS.

2. The first apparatus of claim 1, wherein the machine learning model is configured to map input of a first dimension to output of a second dimension, and wherein the at least one processor is configured to cause the first apparatus to:
generate an input vector based at least in part on the first dimension; and
generate the channel estimate according to the second dimension and based at least in part on the one or more model parameters and the input vector.

3. The first apparatus of claim 2, wherein the at least one processor is configured to cause the first apparatus to generate the input vector as a random vector comprising one or more of a multi-variate random Gaussian vector or a random vector with independently and uniformly distributed elements.

4. The first apparatus of claim 2, wherein the at least one processor is configured to cause the first apparatus to generate the input vector based on a pre-training of the machine learning model, where the pre-training of the machine learning model is performed based at least in part on a dataset comprising channel samples and respective RS.

5. The first apparatus of claim 2, wherein the at least one processor is configured to cause the first apparatus to receive a configuration message for the machine learning model comprising one or more of an architecture of the machine learning model, the first dimension, the second dimension, a number of neurons, or a type of activation function.

6. The first apparatus of claim 1, wherein the machine learning model comprises one or more of a parameterized generative model or a deep neural network.

7. The first apparatus of claim 1, wherein the at least one processor is configured to cause the first apparatus to receive one or more of mean values or covariance values of the one or more model parameters of the machine learning model.

8. The first apparatus of claim 7, wherein the at least one processor is configured to cause the first apparatus to further determine the one or more model parameters based at least in part on the one or more of the mean values or the covariance values, in addition to the one or more RS.

9. The first apparatus of claim 1, wherein the first apparatus comprises one of a user equipment (UE) or a network equipment.

10. A user equipment (UE) for wireless communication, comprising:
at least one memory; and
at least one processor coupled with the at least one memory and configured to cause the UE to:
receive one or more reference signals (RS) that correspond to one or more RS resources for a channel; and
generate a channel estimate for the channel via a machine learning model, wherein one or more model parameters for the machine learning model are configured based at least in part on the one or more RS.

11. A processor for wireless communication, comprising:
at least one controller coupled with at least one memory and configured to cause the processor to:
receive one or more reference signals (RS) that correspond to one or more RS resources for a channel; and
generate a channel estimate for the channel via a machine learning model, wherein one or more model parameters for the machine learning model are configured based at least in part on the one or more RS.

12. The processor of claim 11, wherein the machine learning model is configured to map input of a first dimension to output of a second dimension, and wherein the at least one controller is configured to cause the processor to:
generate an input vector based at least in part on the first dimension; and
generate the channel estimate according to the second dimension and based at least in part on the one or more model parameters and the input vector.

13. The processor of claim 12, wherein the at least one controller is configured to cause the processor to receive a configuration message for the machine learning model comprising one or more of an architecture of the machine learning model, the first dimension, the second dimension, a number of neurons, or a type of activation function.

14. The processor of claim 12, wherein the at least one controller is configured to cause the processor to generate the input vector based at least in part on a pre-training of the machine learning model, where the pre-training of the machine learning model is performed based at least in part on a dataset comprising channel samples and respective RS.

15. The processor of claim 11, wherein the machine learning model comprises one or more of a parameterized generative model or a deep neural network.

16. A second apparatus for wireless communication, comprising:
at least one memory; and
at least one processor coupled with the at least one memory and configured to cause the second apparatus to:
transmit one or more reference signals (RS) that correspond to one or more RS resources for a channel; and
transmit a configuration message for a machine learning model configured to generate a channel estimate for the channel using model parameters determined based at least in part on the one or more RS.

17. The second apparatus of claim 16, wherein the configuration message for the machine learning model comprises one or more of an architecture of the machine learning model, a first dimension for input of the machine learning model, a second dimension for output of the machine learning model, a number of neurons, or a type of activation function.

18. The second apparatus of claim 16, wherein the machine learning model comprises one or more of a parameterized generative model or a deep neural network.

19. The second apparatus of claim 16, wherein the at least one processor is configured to cause the second apparatus to transmit one or more of mean values or covariance values of one or more model parameters of the machine learning model.

20. The second apparatus of claim 16, wherein the second apparatus comprises one of a user equipment (UE) or a network equipment.
